(19) United States
(12) Patent Application Publication
(10) Pub. No.: US 2026/0158591 A1
(43) Pub. Date: Jun. 11, 2026

(54) LASER PROCESSING MACHINE AND LASER PROCESSING METHOD

(71) Applicant: DISCO CORPORATION, Tokyo (JP)

(72) Inventors: Junichi Kuki, Tokyo (JP); Kunimitsu Takahashi, Tokyo (JP)

(21) Appl. No.: 19/183,308

(22) Filed: Apr. 18, 2025

(30) Foreign Application Priority Data
May 13, 2024 (JP) 2024-077695

(51) Int. Cl. B23K 26/142

(52) U.S. Cl. CPC B23K 26/142

(57) ABSTRACT

A laser processing machine for processing a workpiece is provided. This laser processing machine includes a holding mechanism configured to hold the workpiece, an irradiation unit configured to apply a laser beam to the workpiece held on the holding mechanism, an ejection unit configured to eject rinse liquid against the workpiece held on the holding mechanism, a recovery unit configured to recover the rinse liquid ejected against a front surface of the workpiece held on the holding mechanism, and a moving mechanism configured to move the irradiation unit and the holding mechanism relative to each other.

### BACKGROUND OF THE INVENTION

### Field of the Invention

The present invention relates to a machine and a method for performing laser processing on a workpiece such as a semiconductor wafer.

### Description of the Related Art

There is known a technique that, to a wafer formed with a semiconductor or the like, a pulsed laser beam of a wavelength having absorptivity for the material of the wafer is applied to cut the wafer or to form grooves in the wafer by ablation processing.

On a front surface of the wafer, a plurality of scribe lines (streets) is set in a grid pattern, and devices are formed in the respective ones of regions surrounded by the streets. When the wafer is cut by ablation processing, the laser beam is applied along the streets. Upon this ablation processing, swarf called “debris” occurs.

Particles like debris can cause a failure, so that their removal by rinsing is needed. As such a technique, a method has been proposed in which a front surface of a wafer before its ablation processing is covered beforehand with a protective film formed of a water-soluble resin, and after the processing, debris is rinsed off along with the protective film (see, for example, JP 2004-188475A). Another method has also been proposed in which, upon rinsing after ablation processing, a gas-liquid mixed fluid (twin fluid) in which rinse water such as pure water and gas such as air are mixed is used (see, for example, JP 2022-35059A).

### SUMMARY OF THE INVENTION

Incidentally, if ablation processing by a laser beam and subsequent rinsing are performed as mentioned above, the processing and rinsing are performed, for example, by procedures that first apply the ablation processing to a wafer in a laser processing chamber and then move the wafer to a rinsing chamber to perform rinsing.

In order to avoid sticking of mist, which occurs during rinsing, to a laser processing machine, a laser processing step and a rinsing step are separately performed as mentioned above. According to such procedures, however, labor and time are required for work to move the wafer between the laser processing chamber and the rinsing chamber, thereby raising a problem of lowering the productivity.

An object of the present invention is to provide a laser processing machine and a laser processing method, which can efficiently perform laser processing and rinsing on a workpiece.

In accordance with a first aspect of the present invention, there is provided a laser processing machine for processing a workpiece. The laser processing machine includes a holding mechanism configured to hold the workpiece, an irradiation unit configured to apply a laser beam to the workpiece held on the holding mechanism, an ejection unit configured to eject rinse liquid against the workpiece held on the holding mechanism, a recovery unit configured to recover the rinse liquid ejected against a front surface of the workpiece held on the holding mechanism, and a moving mechanism configured to move the irradiation unit and the holding mechanism relative to each other.

In the first aspect of the present invention, the ejection unit and the recovery unit may preferably be integrally configured as an ejection and recovery unit, and the ejection and recovery unit may preferably include a rinse nozzle including a rinse liquid flow path, and a recovery nozzle including a suction port such that the suction port surrounds an ejection port of the rinse nozzle to suck the rinse liquid along with gas.

In the first aspect of the present invention, the laser processing machine may be configured such that the rinse liquid can be ejected from the ejection unit against the front surface of the workpiece under irradiation with the laser beam by the irradiation unit.

In the first aspect of the present invention, the laser processing machine may be configured such that the rinse liquid can be ejected from the ejection unit against the front surface of the workpiece after irradiation with the laser beam by the irradiation unit.

In the first aspect of the present invention, the laser processing machine may include a measurement unit configured such that the front surface of the workpiece held on the holding mechanism can be measured.

In accordance with a second aspect of the present invention, there is provided a laser processing method for processing a workpiece. The laser processing method includes holding the workpiece on a holding mechanism configured to hold the workpiece, applying a laser beam to the workpiece held on the holding mechanism, ejecting rinse liquid against a front surface of the workpiece held on the holding mechanism, and recovering the rinse liquid ejected against the front surface of the workpiece while the rinse liquid is ejected against the front surface of the workpiece held on the holding mechanism.

According to the laser processing machine of the first aspect of the present invention and the laser processing method of the second aspect of the present invention, the laser processing and its subsequent rinsing are performed in the same space, thereby enabling to obviate labor and time of moving the workpiece for its rinsing after the laser processing.

The above and other objects, features and advantages of the present invention and the manner of realizing them will become more apparent, and the invention itself will best be understood from a study of the following description and appended claims with reference to the attached drawings showing preferred embodiments of the invention.

### BRIEF DESCRIPTION OF THE DRAWINGS

FIG. 1 is a perspective view schematically depicting a laser processing machine according to a first embodiment of the first aspect of the present invention;

FIG. 2 is a front view schematically depicting the form of a working unit of the laser processing machine according to the first embodiment;

FIG. 3 is a front cross-sectional view of an ejection and recovery unit in the working unit of FIG. 2;

FIG. 4 is a front cross-sectional view depicting a modification of the ejection and recovery unit of FIG. 3;

FIG. 5 is a flow chart illustrating one example of procedures of a laser processing method according to a first embodiment of the second aspect of the present invention, which uses the laser processing machine;

FIG. 6 is a flow chart illustrating an example of conventional procedures of a laser processing method;

FIG. 7 is a front view schematically depicting the form of a working unit of a laser processing machine according to a second embodiment of the first aspect of the present invention; and

FIG. 8 is a front cross-sectional view of an irradiation and recovery unit in the working unit of FIG. 7.

### DETAILED DESCRIPTION OF THE PREFERRED EMBODIMENTS

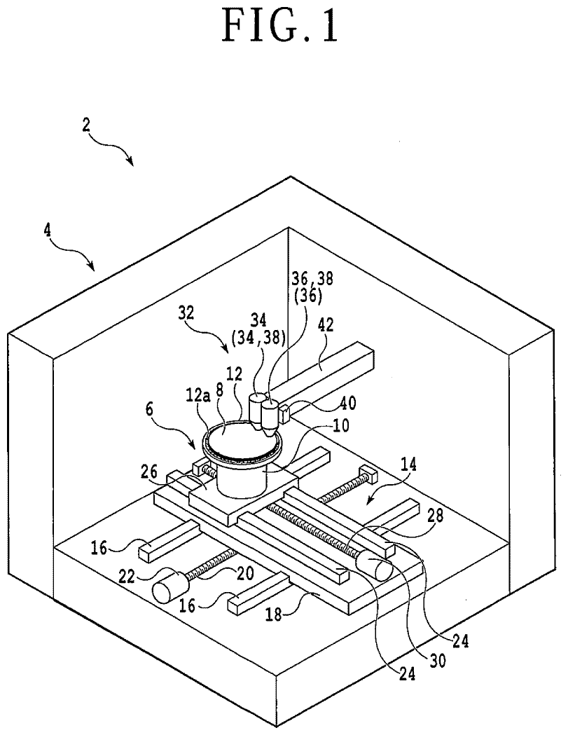

With reference to the attached drawings, a description will hereinafter be made in detail about embodiments of the present invention. FIG. 1 is a perspective view schematically depicting a configuration example of a laser processing machine 2 according to a first embodiment. The laser processing machine 2 is configured including a housing 4 forming a space in which laser processing and rinsing are performed, a support table 6 as a holding mechanism, and a working unit 32. The support table 6 and the working unit 32 are disposed inside the housing 4.

The support table 6 is a table that supports a workpiece 8, such as a wafer, as an object to be processed by the laser processing machine 2. The support table 6 includes a table base 10 supported so as to move back and forth/left and right, by a moving mechanism 14, and a chuck table 12 mounted on the table base 10, and is configured as the holding mechanism to hold the workpiece 8.

The chuck table 12 is mounted rotatably about an axis, which extends along a vertical direction, relative to the table base 10. The chuck table 12 has an upper surface, which functions as a holding surface 12a that holds the workpiece 8 under a negative pressure transmitted from an undepicted suction source such as an ejector.

The support table 6 is disposed near a bottom portion of the housing 4 that defines a parallelepiped space, and is configured to be movable in the space of the housing 4 along a horizontal direction by the moving mechanism 14. The moving mechanism 14 is a mechanism that moves the workpiece 8 relative to an irradiation unit 34, ejection unit 36, recovery unit 38, and measurement unit 40 all of which make up the working unit 32. In the laser processing machine 2 of the present embodiment, the moving mechanism 14 is configured to perform a relative movement between the workpiece 8 and the working unit 32 by moving the support table 6 relative to the working unit 32 supported at a specific position in the housing 4.

The moving mechanism 14 has, for example, a configuration as will be described hereinafter, and supports the support table 6 so as to move back and forth/left and right along the horizontal direction.

On a bottom surface of the housing 4, a pair of Y-axis guide rails 16 is fixed extending in parallel to each other. On the Y-axis guide rails 16, a Y-axis moving table 18 is attached slidably along a length direction of the Y-axis guide rails 16.

Between the paired Y-axis guide rails 16, a Y-axis ball screw 20 is disposed along the length direction of the Y-axis guide rails 16. On a back surface (lower surface) of the Y-axis moving table 18, a nut portion (not depicted) is disposed. The Y-axis ball screw 20 extends through the nut portion, and is in thread engagement with the nut portion. To one end portion of the Y-axis ball screw 20, a Y-axis pulse motor 22 is connected.

When the Y-axis pulse motor 22 is operated, the Y-axis ball screw 20 rotates about its axis, so that the Y-axis moving table 18 moves on the Y-axis guide rails 16 along a direction in which the Y-axis guide rails 16 extend.

On a front surface (upper surface) of the Y-axis moving table 18, a pair of X-axis guide rails 24, which is arranged in a direction substantially orthogonal to the Y-axis guide rails 16 as seen in a plan view, is fixed. On the X-axis guide rails 24, an X-axis moving table 26 is attached slidably along a length direction of the X-axis guide rails 24.

Between the paired X-axis guide rails 24, an X-axis ball screw 28 is disposed along the length direction of the X-axis guide rails 24. On a back surface (lower surface) of the X-axis moving table 26, a nut portion (not depicted) is disposed. The X-axis ball screw 28 extends through the nut portion, and is in thread engagement with the nut portion. To one end portion of the X-axis ball screw 28, an X-axis pulse motor 30 is connected.

When the X-axis pulse motor 30 is operated, the X-axis ball screw 28 rotates about its axis, so that the X-axis moving table 26 moves on the X-axis guide rails 24 along a direction in which the X-axis guide rails 24 extend.

On a front surface (upper surface) of the X-axis moving table 26, the table base 10 is fixed. On the table base 10, the chuck table 12 that holds the workpiece 8 thereon is attached. By operation of the Y-axis pulse motor 22 and X-axis pulse motor 30 included in the moving mechanism 14, the chuck table 12 is moved crisscross along the horizontal direction in the housing 4.

In an upper part inside the housing 4, the working unit 32 is disposed. The working unit 32 includes the irradiation unit 34, the ejection unit 36, the recovery unit 38, and the measurement unit 40. The irradiation unit 34, the ejection unit 36, the recovery unit 38, and the measurement unit 40 are attached to a distal end of an arm-shaped support member 42, and are supported above the chuck table 12.

The irradiation unit 34 is an irradiation system that applies a laser beam from above to the workpiece 8 supported on the holding surface 12a of the chuck table 12. The ejection unit 36 is a rinse nozzle that ejects rinse liquid against the workpiece 8. The recovery unit 38 is a suction nozzle that recovers the rinse liquid ejected against the workpiece 8.

It is to be noted that, in the embodiments to be described hereinafter, a suction nozzle which recovers the rinse liquid along with surrounding gas (air) is assumed as the recovery unit 38, but no particular limitation is imposed on the recovery unit 38 insofar as the rinse liquid can be appropriately recovered. For example, the recovery unit 38 may be a mechanism of such a configuration that a liquid-absorbing fibrous or spongy material is included to wipe off the liquid on the front surface of the workpiece.

The laser processing machine 2 of the present embodiment is configured such that the irradiation unit 34, the ejection unit 36, and the recovery unit 38 are arranged on the distal end of the same support member 42, and the processing by the application of the laser beam and the ejection and recovery of the rinse liquid can be performed concurrently or in parallel in the same space. Specific configurations of the irradiation unit 34, the ejection unit 36, and the recovery unit 38, and processing and rinsing procedures will be mentioned in detail later.

The measurement unit 40 is configured including a laser microscope, a white light interferometer, or the like, and is configured such that the workpiece 8 after ablation processing by the irradiation unit 34 and the workpiece 8 after rinsing by the ejection unit 36 can be optically measured at the front surface thereof.

The support member 42 is an arm-shaped member that extends from a point on a side surface of the housing 4 to a central part of the space in the housing 4, is fixed at a proximal end portion thereof on the side surface of the housing 4, is provided at a distal end thereof with the working unit 32, and is configured to support the working unit 32 above the chuck table 12 by a cantilever structure.

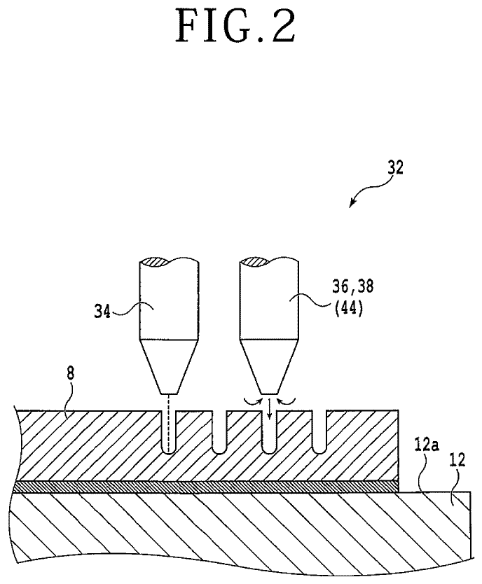

FIG. 2 depicts a front view of the working unit 32 in the first embodiment. The working unit 32 in the first embodiment is configured including an ejection and recovery unit 44 that is adjacent to the irradiation unit 34 and integrally includes a construction as the ejection unit 36 and another construction as the recovery unit 38.

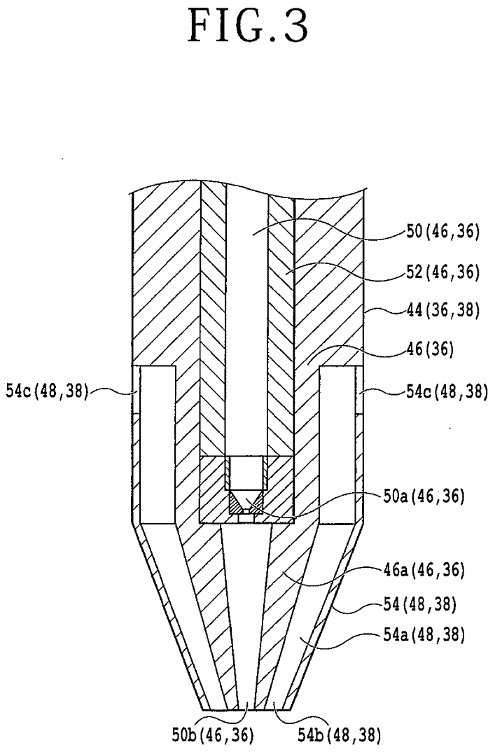

The construction of the ejection and recovery unit 44 is, for example, as depicted in FIG. 3. FIG. 3 is a front cross-sectional view depicting the internal construction of the ejection and recovery unit 44 in the first embodiment. The ejection and recovery unit 44 is a structure configured by combining a rinse nozzle 46 as the ejection unit 36 to eject the rinse liquid and a suction nozzle 48 as the recovery unit 38 to suck the liquid and air.

The ejection and recovery unit 44, which has a cylindrical shape extending in an up-down direction as a whole, includes, along a central axis thereof, a rinse liquid flow path 50 as a flow path through which the rinse liquid flows. Of the ejection and recovery unit 44, a portion that forms the rinse liquid flow path 50 corresponds to the rinse nozzle 46 as the ejection unit 36. The rinse nozzle 46 extends to a tip (lower end) of the ejection and recovery unit 44, and is formed particularly small in diameter around a tip thereof (this portion will be called a “nozzle tip portion 46a” for the sake of convenience).

Accommodated inside the rinse nozzle 46 is a main body portion 52 as a nozzle tip for use in high-pressure water jet cutting. Inside the main body portion 52, a cylindrical space is formed along a central axis of the main body portion 52, and this space forms a portion of the rinse liquid flow path 50 in the rinse nozzle 46. Near a distal end of the rinse liquid flow path 50 disposed inside the main body portion 52, a reduced-diameter portion 50a of an inverted circular cone shape with a flow path diameter progressively decreasing toward a distal end side (downward) is disposed.

This reduced-diameter portion 50a is configured such that the rinse liquid, which flows through the rinse liquid flow path 50, is released after having been constricted in diameter to approximately 100 μm. Of the main body portion 52, a portion that forms this reduced-diameter portion 50a is constructed with a material of high hardness, such as artificial diamond or artificial corundum, to suppress wear by the high-pressure rinse liquid.

At a tip portion of the ejection and recovery unit 44, an outer peripheral portion 54 is disposed so as to surround the nozzle tip portion 46a, which is formed small in diameter, of the rinse nozzle 46. This outer peripheral portion 54 includes an internal space that accommodates the nozzle tip portion 46a, and is open at a lower end portion thereof, so that the outer wall portion 54 functions as the suction nozzle 48.

Specifically, the outer wall portion 54 surrounds an outer side in a radial direction of the nozzle tip portion 46a, and a space between an inner peripheral surface of the outer wall portion 54 and the nozzle tip portion 46a serves as a suction flow path 54a as a flow path through which the liquid and air flow upon their suction. Upon suction, the opening disposed in the lower end portion of the outer wall portion 54 functions as a suction port 54b that is an inlet for the liquid and air.

Of the ejection and recovery unit 44, a portion that forms the suction flow path 54a corresponds to the suction nozzle 48 as the recovery unit 38.

When the ejection and recovery unit 44 is seen from a tip side (a lower side in FIG. 3), the outer wall portion 54 opens in a circle at a central area thereof, the nozzle tip portion 46a is located at the central area, and an outlet (referred to as an “ejection port 50b”) of the rinse liquid flow path 50 centrally opens in the nozzle tip portion 46a. In other words, the suction port 54b, through which the ejected rinse liquid is sucked and recovered, is located concentrically with the ejection port 50b, through which the rinse liquid is ejected, such that the suction port 54b surrounds the ejection port 50b.

In the outer wall portion 54 surrounding the nozzle tip portion 46a, draw ports 54c that are orifices radially extending through the outer wall portion 54 are disposed at positions on a side of a proximal end thereof. To the draw ports 54c, an undepicted suction system is connected, so that a negative pressure is applied from the suction system into the suction flow path 54a through the draw ports 54c upon suction.

The outer wall portion 54 is formed in a tapered shape at a distal end portion thereof so that the distal end portion decreases in diameter toward the suction port 54b. Corresponding to the distal end portion of the outer wall portion 54, the nozzle tip portion 46a that is located on an inner side of the distal end portion of the outer wall portion 54 is also formed in a tapered shape so that the nozzle tip portion 46a also decreases in diameter toward the ejection port 50b.

A description will next be made of the dimensions of individual portions of the ejection and recovery unit 44 constructed by the rinse nozzle 46 (ejection unit 36) and the suction nozzle 48 (recovery unit 38).

The width of the suction flow path 54a is defined as a distance between the outer peripheral surface of the nozzle tip portion 46a and the inner peripheral surface of the outer wall portion 54. This width is suitably set, for example, to approximately 1 mm or greater and 3 mm or smaller. If the width of the suction flow path 54a is too narrow, there is a possible problem that a clog may occur in the suction flow path 54a upon recovery of the rinse liquid from the suction port 54b. If the width of the suction flow path 54a is too large, on the other hand, there is a possible problem that droplets of the rinse liquid sucked into the suction flow path 54a drip to the suction port 54b, and may not be recovered well from the draw ports 54c.

The diameter of the suction port 54b of the suction flow path 54a is suitably set, for example, to approximately 1 mm or greater and 10 mm or smaller. If the suction port 54b is too narrow, the range in which the rinse liquid can be sucked, in other words, the range in which a negative pressure of such a magnitude as to enable suction for the scattered rinse liquid can be applied from the suction port 54b becomes narrow, and therefore efficient recovery of the rinse liquid is hardly feasible. If the suction port 54b is too wide, on the other hand, there is a possible problem that no sufficient suction force is available.

The diameter of the ejection port 50b may suitably be set, for example, to approximately 0.5 mm or greater and 2 mm or smaller. If the diameter of the ejection port 50b is too large, there is a possible problem that air to be sucked in from the suction port 54b of the suction flow path 54a may flow from the ejection port 50b into the rinse liquid flow path 50 to cause difficulty in the ejection of the rinse liquid, and therefore the diameter of the ejection port 50b should be narrowed to a certain extent. If the diameter of the rinse liquid flow path 50 is too small, on the other hand, an excessively high pressure is needed for the ejection of the rinse liquid.

It is suitable to configure that, with respect to the direction of the central axis (up-down direction) of the ejection and recovery unit 44, the position of the ejection port 50b and the position of the suction port 54b coincide with each other or that the ejection port 50b is located a little deeper (on a proximal end side, on an upper side) relative to the suction port 54b. Specifically, the difference in position between the ejection port 50b and the suction port 54b with respect to the direction of the central axis of the ejection and recovery unit 44 may be set to 0 mm or greater and 5 mm or smaller.

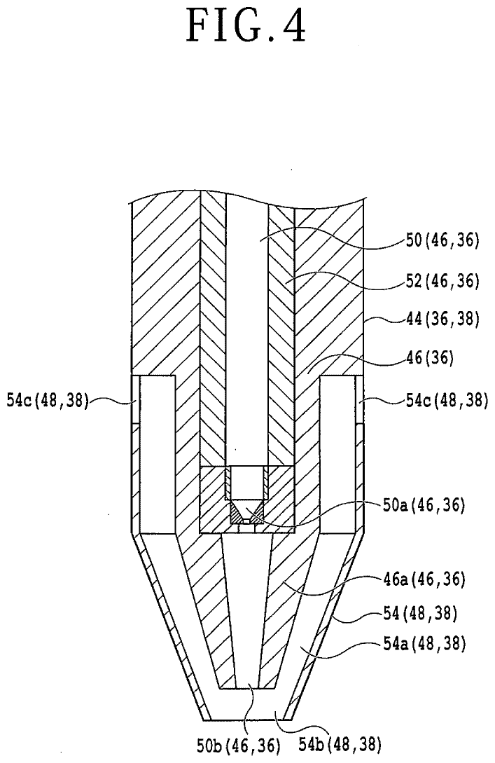

FIG. 3 depicts a configuration in a case where the ejection port 50b and the suction port 54b are at the same position with respect to the direction of the central axis of the ejection and recovery unit 44. FIG. 4 depicts, as a modification, a configuration in a case where the ejection port 50b is at a little deeper position relative to the suction port 54b with respect to the direction of the central axis of the ejection and recovery unit 44.

If the ejection port 50b is at a substantially deeper position relative to the suction port 54b, there is a possible problem that an air stream, which occurs by the suction from the suction port 54b, flows from the ejection port 50b into the rinse liquid flow path 50 and a difficulty may arise in the ejection of the rinse liquid.

If the ejection port 50b projects distally of the suction port 54b, on the other hand, the distance between a region, to which the rinse liquid is ejected, and the suction port 54b increases with the projecting amount, thereby making it difficult to efficiently suck and recover the scattered rinse liquid.

Further, to ensure a sufficient suction force and to promptly recover the ejected rinse liquid, it is desired to make the distance as small as possible between the suction port 54b and the workpiece 8 (for example, approximately 1 mm or smaller). If the ejection port 50b projects from the suction port 54b, it is correspondingly difficult to bring the suction port 54b and the workpiece 8 closer to each other.

At the time of use, approximately 50 ml per minute of the rinse liquid is ejected, for example, at a pressure of approximately 0.5 MPa or higher and 3 MPa or lower through the rinse liquid flow path 50. Consequently, the rinsing of the workpiece 8 is performed. The rinse liquid is, for example, pure water, but liquid other than pure water can be also used. For example, a substance such as a surfactant may be mixed in water. In addition, twin-fluid rinsing may also be performed by mixing gas such as air in the rinse liquid.

At the same time, a negative pressure is applied from the undepicted suction system, which is connected to the draw ports 54c, to the inside of the suction flow path 54a, and the rinse liquid ejected against the workpiece 8 is sucked along with the surrounding air from the suction port 54b. The suction is performed, for example, at a flow rate of approximately 120 L per minute and under a negative pressure of approximately 3.3 kPa. From the suction port 54b, the rinse liquid ejected against the workpiece 8 is recovered in a state where components of a water-soluble protective film applied to the front surface of the workpiece 8 are dissolved and debris occurred by ablation processing is contained.

The flow rate of a draw from the draw ports 54c may be set with the choking phenomenon taken into consideration. In a system where gas flows through a nozzle, the flow rate when the back pressure on an exit side is lowered beyond a certain threshold is equal to the flow rate when the back pressure is set to the threshold. This is the choking phenomenon. It is therefore meaningless to lower, beyond a certain threshold, the negative pressure that is to be applied to the suction flow path 54a from the undepicted suction system connected to the draw ports 54c.

The negative pressure to be applied to the suction flow path 54a can perform suction with a high efficiency without wasting energy required for the generation of the negative pressure if the negative pressure is set to such a level that the maximum flow rate calculated on the basis of the choking phenomenon can be realized. The above-mentioned numerical value of 120 L per minute is an example of the flow rate as calculated on the basis of the choking phenomenon in the ejection and recovery unit 44 having such dimensions as described above.

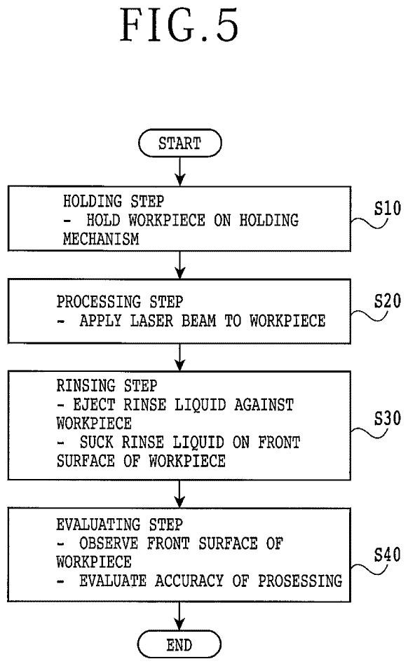

A description will be made of procedures in a case in which laser processing is applied to the workpiece 8 using the laser processing machine 2 having the foregoing configurations. FIG. 5 is a flow chart illustrating one example of procedures of a laser processing method according to a first embodiment of the second aspect of the present invention, which uses the laser processing machine 2.

First, the workpiece 8 is held on the holding surface 12a of the chuck table 12 (holding step: Step S10). Then, laser processing is performed on the workpiece 8 on the chuck table 12 (processing step: Step S20). Irradiation with a laser beam from the irradiation unit 34 of the working unit 32 is performed, and concurrently with the irradiation, the chuck table 12 located below the working unit 32 is moved along the horizontal direction by the moving mechanism 14. Consequently, processing such as cutting or formation of grooves is performed on the workpiece 8 held on the chuck table 12. Accompanying with the processing, swarf occurs around the workpiece 8.

In parallel with the processing step (Step S20), rinsing of the workpiece 8 by the ejection and recovery unit 44 is performed (rinsing step: Step S30). The rinse liquid is ejected from the ejection port 50b against the front surface of the workpiece 8 held on the chuck table 12, swarf occurred in the processing step is mixed with the rinse liquid, and the components of the protective film covering the front surface of the workpiece 8 are dissolved in the rinse liquid.

In the rinsing step (Step S30), the rinse liquid is sucked, in parallel with the rinsing, from the suction port 54b disposed surrounding the ejection port 50b and through the suction flow path 54a, and therefore the rinse liquid is recovered along with the swarf and the components of the protective film. Upon this recovery, an air stream occurs around the suction port 54b accompanying with the suction of the liquid and air from the suction port 54b, the component of the rinse liquid scattered over the front surface of the workpiece 8 is caused to evaporate by the air stream, and with the workpiece 8 kept held on the chuck table 12, drying of the front surface of the workpiece 8 is performed.

The ejection and recovery unit 44 is attached together with the irradiation unit 34 to the distal end of the support member 42, and constitutes a part of the working unit 32. When the ejection and recovery of the rinse liquid are to be performed by the ejection and recovery unit 44, the relative positional relation between the irradiation unit 34 and the ejection and recovery unit 44 and the relative moving directions of the working unit 32 and the workpiece 8 are set beforehand such that the ejection and recovery unit 44 is located, for example, on a downstream side with respect to the advancing direction of processing by the irradiation unit 34 on the workpiece 8.

The chuck table 12 is then moved together with the workpiece 8 relative to the working unit 32 while the irradiation with the laser beam from the irradiation unit 34, the ejection of the rinse liquid from the ejection port 50b of the ejection and recovery unit 44, and the suction of the liquid and air from the suction port 54b are concurrently performed. Consequently, the laser processing of the workpiece 8 by the irradiation unit 34 (processing step: Step S20) and the rinsing of the processed part and the recovery of the rinse liquid by suction (rinsing step: Step S30) are performed in parallel.

It is to be noted that, in FIG. 5, Step S30 is illustrated after Step S20, but in the above-mentioned procedures, Step S20 and Step S30 can be actually performed concurrently or in parallel as described above.

Here, if the position of the processing by the irradiation unit 34 and the position of the rinsing by the ejection and recovery unit 44 are shifted on the front surface of the workpiece 8 as depicted in FIG. 2, the rinsing and the recovery of the rinse liquid are performed on the front surface of the workpiece 8 after the laser beam has been applied by the irradiation unit 34 and the laser processing has been applied. In this case, the rinsing step is initiated a little after the initiation of the processing step, but after the initiation of the rinsing step, both of the steps proceed substantially concurrently and in parallel.

Moreover, by adjusting, for example, the position of the ejection unit 36 relative to the irradiation unit 34, the rinse liquid can be precisely ejected against the part, where a processed groove has been formed by laser processing, as depicted in FIG. 2. During the processing, swarf naturally occurs at the part subjected to the laser processing. Therefore, by ejecting the rinse liquid precisely against the part, effective rinsing can be performed by minimum necessary rinsing, and advantageous effects such as saving of the rinse liquid and improvements in productivity can be obtained accordingly.

It is to be noted that although depiction is omitted herein, the irradiation with the laser beam and the ejection of the rinse liquid may be concurrently performed to the same region on the front surface of the workpiece 8 by tilting the ejection and recovery unit 44 such that the ejection line of the rinse liquid crosses the irradiation line of the laser beam applied from the irradiation unit 34. In this case, against the front surface of the workpiece under irradiation with the laser beam by the irradiation unit 34, the rinse liquid is ejected from the ejection unit 36, and the recovery of the rinse liquid is also performed.

The front surface of the workpiece 8 after the processing step, the rinsing step, and the recovering step is observed by the measurement unit 40 disposed in the working unit 32, and is evaluated for the accuracy of processing, and the like (evaluating step: Step S40). In this evaluating step, the front surface of the workpiece 8, which has been rinsed in the preceding rinsing step and has been rendered free of the rinse liquid, is optically observed and evaluated, so that the front surface of the workpiece 8 in a state of being free of remaining swarf and liquid droplets can be observed, and high-precision evaluation is possible.

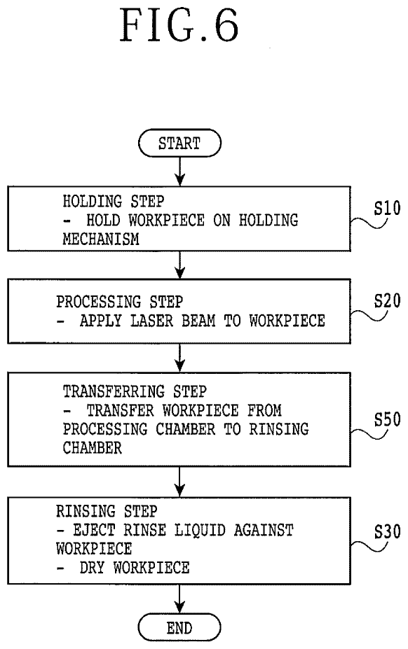

FIG. 6 is a flow chart illustrating, as a referential example, an example of procedures in conventional laser processing. With a conventional laser processing machine, a series of steps has been performed by procedures that, after laser processing is performed on a workpiece in a processing chamber including a laser irradiation unit (Steps S10 to S20), the workpiece is moved to a rinsing chamber (transferring step: Step S50), the workpiece is rinsed with rinse liquid in the rinsing chamber (Step S30), and after removal of the rinse liquid and drying of the workpiece, the workpiece is moved to the next step.

In such conventional procedures, after laser processing is fully performed on a single workpiece, the workpiece is moved to another chamber, followed by its rinsing. Therefore, the processing step (Step S20) and the rinsing step (Step S30) cannot be performed in parallel, and in addition, labor (Step S50) is needed to move the workpiece between the processing step and the rinsing step. This has been a cause of limitation to improvements in the manufacturing efficiency on the processing of workpieces.

In contrast, in the laser processing machine 2 of this first embodiment, the irradiation unit 34, and the ejection unit 36 and recovery unit 38 (ejection and recovery unit 44) are attached as the working unit 32 to the same support member 42, thereby allowing to perform the laser processing and its subsequent rinsing in the same space.

With the conventional laser processing machine, there is a background that a space for performing processing and a space for performing rinsing are separated by the intention of avoiding a reduction in the quality of a laser beam due to sticking of rinse liquid and the like to a system for the irradiation with the laser beam. Because mist occurs when rinse liquid is ejected at a high pressure against the front surface of a workpiece, it has been avoided to install a laser unit in a space to be filled with the mist.

In contrast, in the laser processing machine 2 of this first embodiment, the rinse nozzle 46 as the ejection unit 36 to eject the rinse liquid and the suction nozzle 48 as the recovery unit 38 to perform the recovery of the rinse liquid are integrally constructed in the form of the ejection and recovery unit 44, the suction port 54b that sucks the liquid and air is included at a position very close to the ejection port 50b that ejects the rinse liquid, and after the rinse liquid is ejected against the workpiece 8 to perform rinsing, the rinse liquid is promptly recovered, and the workpiece 8 is dried.

Even if mist occurs by the ejection of the rinse liquid, the mist is quickly sucked to suppress sticking of liquid droplets to the irradiation unit 34. This has enabled to perform the processing step and the rinsing step in the same space.

In a processing method using the laser processing machine 2 of this first embodiment, the labor and time (Step S50) to move the workpiece 8 to the rinsing chamber after the laser processing are not needed. Moreover, instead of performing the rinsing step (Step S30) after the processing step (Step S20) is finished, the processing step and the rinsing step can be performed in parallel, and therefore the time required for the processing to rinsing is further shortened.

Furthermore, the system for laser processing (irradiation unit 34) and the system for rinsing (ejection and recovery unit 44) are held in close proximity to each other on the same support member 42, and the front surface of the workpiece 8 subjected to laser processing by the irradiation unit 34 can be rinsed with pinpoint accuracy concurrently with the laser processing or shortly after the laser processing. A quick rinse with high rinsing power is therefore possible.

It is to be noted that the description has been made above of the case in which the processing step and the rinsing step are performed in parallel, but the rinsing step (Step S30) can also be performed after having gone with the single workpiece 8 through the processing step (Step S20). Also in this case, compared with the conventional procedures illustrated in FIG. 6, labor and time can be saved to the extent that the transferring step (Step S50) is not needed.

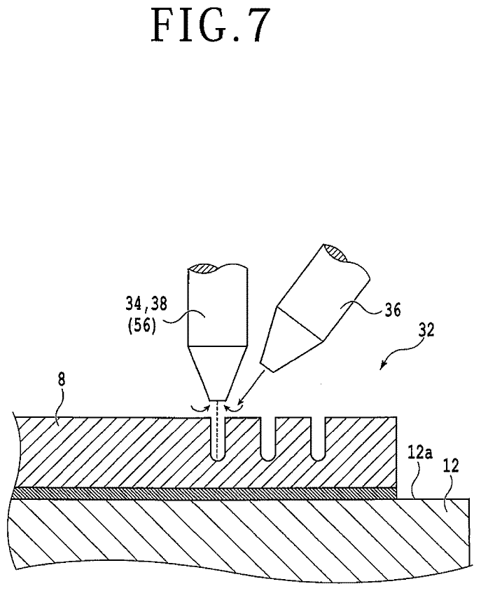

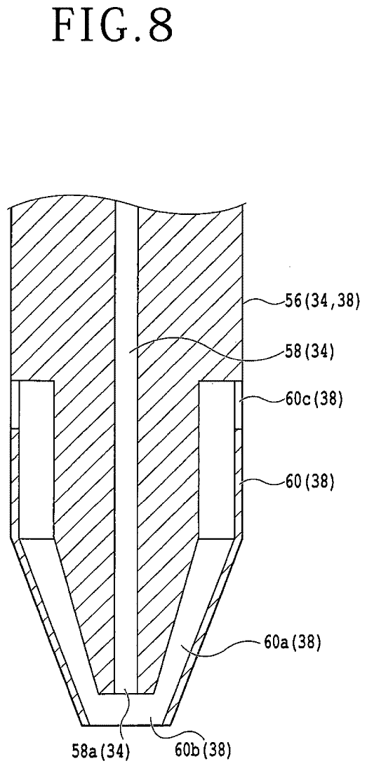

FIG. 7 depicts the form of a working unit of a laser processing machine according to a second embodiment, and FIG. 8 depicts a front cross-sectional view of an irradiation and recovery unit in the working unit of FIG. 7.

In the first embodiment of FIG. 2, among the irradiation unit 34, the ejection unit 36, and the recovery unit 38, the ejection unit 36 and the recovery unit 38 are integrated into the ejection and recovery unit 44. In the second embodiment of FIG. 7, the irradiation unit 34 and the recovery unit 38 are integrated to configure them as an irradiation and recovery unit 56, and the ejection unit 36 is included separately from the irradiation and recovery unit 56.

The construction of the irradiation and recovery unit 56 in the second embodiment is as depicted in FIG. 8. The irradiation and recovery unit 56 that has a cylindrical shape as a whole includes, along a central axis thereof, an optical path 58 to allow passage of a laser beam therethrough. A member, which forms the optical path 58, and a portion, which surrounds and supports the member, correspond to the irradiation unit 34.

Of the irradiation unit 34, a portion around an irradiation port 58a at a tip is formed small in diameter, and an outer wall portion 60 is disposed so as to surround this portion (which will hereinafter be called “the tip portion”). The outer wall portion 60 includes an internal space that accommodates the tip portion, which is formed small in diameter, of the irradiation unit 34, and is open at a lower end portion thereof, so that the outer wall portion 60 functions as a suction nozzle.

The form and function of the outer wall portion 60 as the suction nozzle are substantially similar to those of the outer wall portion 54 in the above-mentioned first embodiment (see FIGS. 2 to 4). The outer wall portion 60 surrounds an outer side in a radial direction of the tip portion of the irradiation unit 34, and a space between an inner peripheral surface of the outer wall portion 60 and the tip portion of the irradiation unit 34 forms a suction flow path 60a as a flow path through which the liquid and air flow upon suction thereof. Upon suction, the opening disposed in the lower end of the outer wall portion 54 functions as a suction port 60b that is an inlet for liquid and air.

When the ejection and recovery unit 56 is seen from a tip side (a lower side in FIG. 8), the outer wall portion 60 opens in a circle at a central area thereof, the tip portion of the irradiation unit 34 is located at the central area, and the irradiation port 58a is centrally located in the tip portion. In other words, the suction port 60b is located concentrically with the irradiation port 58a such that the suction port 60b surrounds the irradiation port 58a.

In the surrounding outer wall portion 60, draw ports 60c that are orifices radially extending through the outer wall portion 60 are disposed at positions on a side of a proximal end thereof. To the draw ports 60c, an undepicted suction system is connected, so that a negative pressure is applied from the suction system into the suction flow path 60a through the draw ports 60c upon suction.

A distal end portion of the outer wall portion 60 is formed in a tapered shape so that the tip portion decreases in diameter toward the suction port 60b.

The ejection unit 36 disposed separately from the irradiation and recovery unit 56 is a nozzle that ejects the rinse liquid, and as depicted in FIG. 7, is arranged in the working unit 32 such that the rinse liquid is ejected in a direction crossing the central axis of the irradiation and recovery unit 56.

Upon processing the workpiece 8, a laser beam is applied to the front surface of the workpiece 8 from the irradiation port 58a of the irradiation and recovery unit 56, and the rinse liquid is ejected from the ejection unit 36 against a region irradiated with the laser beam. Concurrently, a negative pressure is applied to the suction flow path 60a from the undepicted suction system connected to the draw ports 60c of the irradiation and recovery unit 56, and the rinse liquid is sucked and recovered along with air from the suction port 60b.

When the laser processing of the workpiece 8 is performed by the laser processing machine 2 including the working unit 32 of this second embodiment, the rinse liquid is therefore ejected from the ejection unit 36 against the front surface of the workpiece 8 which is under irradiation with the laser beam by the irradiation unit 34.

Similarly to the above-described first embodiment, the laser processing and rinsing of the workpiece 8 can be also performed in the same space and in parallel by this second embodiment. Procedures are similar to those of the flow chart of FIG. 5.

It is to be noted that structures, methods, and the like according to the above-mentioned embodiments are not limited only to those described above. For example, in the above-described first embodiment, the description is made of the example of the case where among the irradiation unit, the ejection unit, and the recovery unit, the ejection unit and recovery unit are integrally configured, and in the above-described second embodiment, the description is made of the example of the case where the irradiation unit and the recovery unit are integrally configured. Without being limited to such forms, laser processing and rinsing can be also performed by similar procedures as in the flow chart of FIG. 5, for example, even in a form that the irradiation unit, the ejection unit, and the recovery unit are configured as discrete devices, and these discrete devices are attached to the distal end of the same support member.

Nonetheless, the working unit can be made more compact if at least some of the irradiation unit, the ejection unit, and the recovery unit are configured to exhibit their functions as a common single unit as in the first and second embodiments.

It is also possible to conceive such a machine that, upon relatively moving the working unit and the workpiece, for example, moves the working unit relative to the workpiece instead of moving the workpiece relative to the working unit. As an alternative, a mechanism may be adopted in which the workpiece is moved in an X-axis direction and the working unit is moved in a Y-axis direction. As appreciated from the foregoing, machines of various configurations can be conceived as the laser processing machine without being limited to the above-described embodiments.

Moreover, the above-described embodiments can be changed or modified as appropriate within the scope not departing from the object of the present invention.

The present invention is not limited to the details of the above-described preferred embodiments. The scope of the invention is defined by the appended claims and all changes and modifications as fall within the equivalence of the scope of the claims are therefore to be embraced by the invention.

What is claimed is:

1. A laser processing machine for processing a workpiece, comprising:
a holding mechanism configured to hold the workpiece;
an irradiation unit configured to apply a laser beam to the workpiece held on the holding mechanism;
an ejection unit configured to eject rinse liquid against the workpiece held on the holding mechanism;
a recovery unit configured to recover the rinse liquid ejected against a front surface of the workpiece held on the holding mechanism; and
a moving mechanism configured to move the irradiation unit and the holding mechanism relative to each other.

2. The laser processing machine according to claim 1, wherein
the ejection unit and the recovery unit are integrally configured as an ejection and recovery unit, and
the ejection and recovery unit includes
a rinse nozzle including a rinse liquid flow path, and
a recovery nozzle including a suction port such that the suction port surrounds an ejection port of the rinse nozzle to suck the rinse liquid along with gas.

3. The laser processing machine according to claim 1, wherein
the laser processing machine is configured such that the rinse liquid is capable of being ejected from the ejection unit against the front surface of the workpiece under irradiation with the laser beam by the irradiation unit.

4. The laser processing machine according to claim 1, wherein
the laser processing machine is configured such that the rinse liquid is capable of being ejected from the ejection unit against the front surface of the workpiece after irradiation with the laser beam by the irradiation unit.

5. The laser processing machine according to claim 1, further comprising:
a measurement unit configured such that the front surface of the workpiece held on the holding mechanism is capable of being measured.

6. A laser processing method for processing a workpiece, comprising:
holding the workpiece on a holding mechanism configured to hold the workpiece,
applying a laser beam to the workpiece held on the holding mechanism,
ejecting rinse liquid against a front surface of the workpiece held on the holding mechanism, and
recovering the rinse liquid ejected against the front surface of the workpiece while the rinse liquid is ejected against the front surface of the workpiece held on the holding mechanism.
